(19) United States
(12) Patent Application Publication
(10) Pub. No.: US 2007/0057509 A1
(43) Pub. Date: Mar. 15, 2007

(54) Vent lock

(76) Inventors: Thomas J. Beal, Ossian, IN (US); Michael G. Catenazzo, Van Buren, IN (US)

Correspondence Address: Charles C. Valauskas;BANIAK PINE & GANNON, Suite 1200, 150 N. Wacker Drive, Chicago, IL, 60201, US

(21) Appl. No.: 11/489,278

(22) Filed: Jul. 19, 2006

Related U.S. Application Data
(60) Provisional application No. 60/700,396, filed on Jul. 19, 2005.

(51) Int. Cl. F16L 21/00

(52) U.S. Cl. 285/402

(57) ABSTRACT

A pipe connection, including a male pipe including a male end with a first diameter and preferably a T-shaped channel formed in the male end. The connection includes a female pipe including a female end with a second diameter. The second diameter is larger than the first diameter. A locking bead may formed on the female pipe and is sized and shaped to be received within the T-shaped channel when the male end is inserted into the female end. The locking bead is retained in the T-shaped channel when the male pipe is fully inserted and then radially twisted with respect to the female pipe.

This application claims benefit of U.S. Provisional Application No. 60/700,396, filed Jul. 19, 2005.

### FIELD OF THE INVENTION

The present invention relates to a fireplace flue, and particularly to a connector for use in a fireplace flue. More particularly, the present invention relates to a lock system and methods by which two piping portions of a fireplace flue may be releasably connected securely and efficiently.

### BACKGROUND

Fireplace flues (or vents) are typically constructed of sheet metal that has been formed in the shape of a pipe. The pipe may be any shape, but it is common to use cylindrical pipes so that connecting pipes and elbows can be rotated and positioned in a greater range of possible configurations. For example, the fireplace flue may be configured to extend upwardly away from the fireplace, and then bend 45 or 90 degrees (or any other type of bend) to meet an exit hole in the roof or side wall. Such configurations are facilitated with the use of cylindrical pipes and interlocking pieces that can rotate relative to each other during installation.

The interlocking pieces (pipes) have typically been secured using methods known in the art. One such known method uses a series of pipes, ends of which have male-female relationships to each other such that one end of a pipe may be received in an appropriately sized opening of another. A variety of devices and techniques are known through the use of which the pipes remain connected to each other. For example, pipes are known that include an aperture that opens from one end of a pipe into an L-shape. The L-shaped aperture is sized and shaped to receive snugly a bead that rises from the outer surface of a second pipe generally adjacent to the second pipe's end. The connection of the first pipe to the second pipe is accomplished by inserting the second pipe into the first pipe such that the bead of the second pipe is received in the portion of the L-shaped aperture that opens from the end of the first pipe. With further insertion of the second pipe into the first pipe, the bead can travel along a first length of the L-shaped aperture. Locking connection of the first pipe and second pipe is completed by the rotation of the second pipe so that the bead—after it has traveled completely along the first length of the L-shaped aperture—travels completely along a second length of the L-shaped aperture, the axis of the second length of the L-shaped aperture being generally perpendicular to the axis of the first length of the L-shaped aperture.

### SUMMARY

The present invention is directed to a locking system for piping that may be used, for example, to form fireplace flues (or vents). The locking system of the present invention includes a locking bead that rises from an inner surface of a first pipe generally adjacent to the end of the first pipe. The first pipe includes an opening that is sized and shaped to receive a second pipe therein. The second pipe includes a T-shaped aperture that opens from the end of the second pipe. The T-shaped aperture is sized and shaped to receive snugly the locking bead that rises from the inner surface of the first pipe. In comparison to the L-shaped aperture of known piping connectors, the T-shaped channel of the second pipe advantageously permits locking connection between the first pipe and the second pipe to be accomplished by inserting the locking bead of the first pipe into the receiving length of the T-shaped channel of the second pipe so that the locking bead travels completely along the receiving length, and when fully inserted, rotating the pipes either way relative to each other until the locking bead is captured in the locking length of the T-shaped channel. To permit long lengths of piping to be formed, such as through the use of three or more individual pipes, each of the pipes may include what will be termed for purposes of this application a male end having the T-shaped aperture and at the end of the same pipe opposite to the male end, a female end from the inner surface of which the locking bead rises. Other channel configurations are possible—including a channel that circumscribes the pipe.

The constructions discussed herein permit a greater range of pipe installation options, and permit material cost savings because fewer types of connecting materials are needed. Finally, installation costs may be saved due to easier installation of the parts.

Additional features of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is an elevation view of a single length of pipe comprising a female end having a locking bead that rises from the inside surface of the female end generally adjacent to the insertion end of the female end and a male end having a T-shaped channel for receipt of the locking bead from the female end of a different pipe;

FIG. 2 is a cross-sectional view of a longitudinally extending seam on the pipe;

FIG. 3 is a view of a male end of one pipe (a first pipe) positioned for mating with a female end of another pipe (a second pipe); and

FIG. 4 is a view of the pipes shown in FIG. 3, with the pipes mated and rotated into a locked position.

### DETAILED DESCRIPTION OF THE DRAWINGS

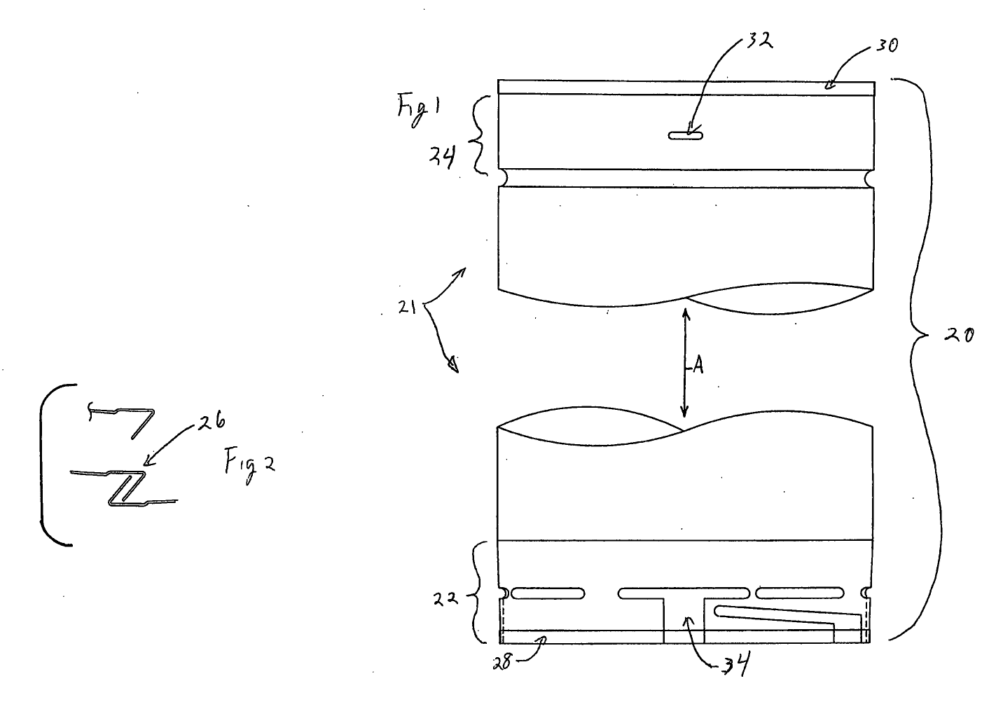

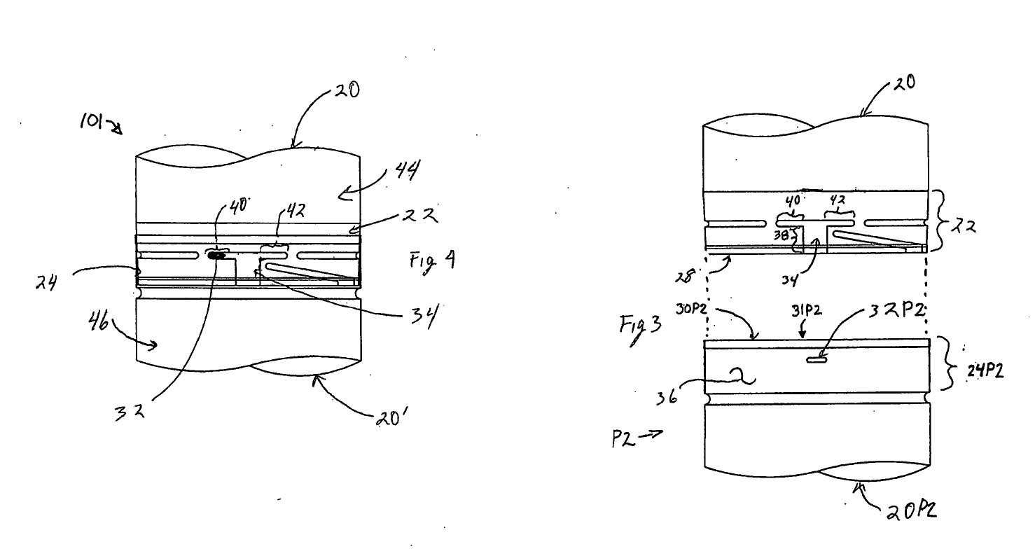

A pipe 20 including a locking system 21 according to the present invention and comprising a male end 22 and a female end 24 is shown in FIG. 1, FIG. 3, and FIG. 4. Although pipe 20 is illustratively constructed of sheet metal rolled in the shape of a cylinder and secured via a longitudinal side seam 26 (shown in FIG. 2), it should be understood that the elements of the present invention can be applied in various other types and constructions of pipes, and the invention is not limited to the illustrated embodiment.

FIG. 1 illustrates an embodiment of a single length of pipe 20 and the locking system 21. Pipe 20 includes a male end 22—having an insertion edge 28 that is configured for insertion into a female end of a second pipe 20 that is not shown in FIG. 1 but which is identified herein as “P2”—and a female end 24—having a receiving edge 30 sized and shaped to receive and sleeve over a male end 22 of a third pipe 20 that is not shown in FIG. 1 but which is identified herein as “P3”. Each length of pipe 20 has an axis “A” along the long axis of the pipe.

FIG. 3 illustrates the use of the locking system 21 to form secure releasable connections between two pipes 20. To assist in the description of the preferred embodiments of the present invention, components of a second pipe 20 used with a first pipe 20 to form a length of piping 101 will be identified with the suffix “P2”. Of course, extended lengths of piping 101 may be formed through the use of more than two pipes 20 and the locking system 21 of the present invention. FIG. 3 illustrates the male end 22 of a first pipe 20 and the female end 24P2 of a second pipe 20′ positioned for mating each other, but spaced apart. Male end 22 has an insertion edge 28 that is sized and shaped to be received by and within receiving edge 30P2 of female end 24P2 of the second pipe 20 also identified as “P2”. Illustratively, female end 24P2 also includes a locking bead 32P2 positioned generally adjacent to receiving edge 30P2 that can be received by T-shaped channel 34.

The embodiment of the locking bead 32P2 shown in FIG. 3 is a convex-shaped element that rises above the inner surface 31 P2 of pipe 20. In the illustrated embodiment, locking bead 32 is formed by forcing (via a punch or other) the sheet metal inwardly in that area of the pipe 20 to yield the convex-shaped portion rising above the inner surface 31P2 of pipe 20. However, it should be understood by one skilled in the art that various other methods of forming locking bead 32 are within the scope of the disclosure.

T-shaped channel 34 (shown in FIG. 2 and FIG. 3) may be formed in a manner similar to that used to form locking bead 32. However, other methods of forming the T-shaped channel 34 are within the scope of the disclosure. Alternatively, T-shaped channel 34 may be a T-shaped aperture into which the locking bead 32 is inserted and rotated.

In the present disclosure, T-shaped channel 34 is formed such that locking bead 32 can pass inside the inner circumference of channel 34 when male end 22 is mated with the female end 24P2 of a second pipe 20. As shown in FIG. 4, once male end 22 is fully mated with female end 24P2, pipe 20 can be turned in either of the two locking lengths 40, 42 of the T-shaped channel 34 that open on an axis that is generally perpendicular to the receiving length 38 of the channel 34 indicated by arrow 44 relative to pipe 20P2 (and/or pipe 20P2 turned in a direction indicated by arrow 46 relative to pipe 20), causing locking bead 32 to move into a locking position, as shown in FIG. 4. Of course, once mated, pipes 20, 20P2 may also be turned in the opposite directions relative to each other, causing locking bead 32 to move into a locking position on the other side of T-shaped channel 34.

T-shaped channel 34 comprises a receiving length 38 and two locking lengths, i.e., first and second transverse lengths 40, 42, which may also be referred to as first and second arms, positioned substantially orthogonal to length 38. In the locking position shown in FIG. 4, locking bead 32 has been moved into arm 40, which prevents pipe 20 from moving longitudinally relative to pipe 20P2 (thereby “locking” pipes 20 and 20P2 in place relative to each other to form a length of piping 101). As noted above, in the alternative, locking bead 32 may be moved into arm 42 in order to create a locked position.

It should be understood that first and second arms 40, 42 may also be formed at something other than 90-degree angles (not shown) to receiving length 38. For example, it may be desirable to have pipes 20 and 20P2 pull closer to each other when locking bead 32 is moved into the locked position. Thus, first and second arms 40 and 42 may be formed at an angle greater than 90 degrees relative to receiving length 38. In the alternative, it may be desirable to have pipes 20 and 20P2 pull slightly away from each other in the locked position. In such a configuration, first and second arms 40, 42 would be formed at less than a 90-degree angle relative to receiving length 38. This configuration may be desirable when pipes 20, 20P2 are subject to forces pulling them apart in a longitudinal direction. Such longitudinal pulling forces would further secure pipes 20, 20P2 in the locked position.

Additional T-shaped channels may be formed in female end 24P2. Such additional T-shaped channels may provide additional positions at which a male end 22 (and locking bead 32) may engage with female end 24′. In the alternative, additional locking beads 32 may be provided on male end 22, further reinforcing the engagement of pipes 20, 20P2.

In an alternative embodiment, shown in dashed lines in FIG. 4, first and second arms 40, 42 may extend a greater or more substantial length about the circumference of male end 22 of pipe 20. In one embodiment, such first and second arms 40, 42, particularly when in the form of a channel, may extend completely about the circumference, allowing pipe 20 to be rotated 360 degrees relative to pipe 20P2. In another embodiment (not shown), but well within the skill of the ordinary worker to contemplate in view of the present disclosure, the locking bead may be formed on the male pipe and the T-shaped channel may be formed on the female pipe.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

There is a plurality of advantages of the present invention arising from the various features of the vent lock described herein. It will be noted that alternative embodiments of the vent lock of the present invention may not include all of the features described yet still benefit from at least some of the advantages of such features. Those of ordinary skill in the art may readily devise their own implementations of such a vent lock that incorporate one or more of the features of the present invention and fall within the spirit and scope of the present invention.

We claim:

1. A piping having releasable lockable connection, comprising:
a female pipe including a female end and a locking bead formed on said female end; and
a male pipe including a male end having a T-shaped channel sized and shaped to receive said locking bead when said male end is inserted into said female end to form piping having releasable lockable connection.

2. The piping of claim 1, wherein said locking bead is retained in said T-shaped channel when said male pipe is fully inserted and then radially twisted with respect to said female pipe.

3. The piping of claim 1, wherein said female end has a first diameter and said male end has a second diameter, said second diameter being smaller than said first diameter.

4. The piping of claim 1, wherein said locking bead protrudes from an inside surface of said female pipe.

5. The piping of claim 1, wherein said female pipe has one locking bead and said male pipe has one T-shaped channel.

6. The piping of claim 1, wherein said female pipe has one or more of said locking bead and said male pipe has one or more of said T-shaped channel.

7. The piping of claim 1, wherein said female pipe has one of said locking bead and said male pipe has a plurality of said T-shaped channels.

8. The piping of claim, 1 wherein said T-shaped channel is a convex shaped element.

9. The piping of claim, 1 wherein said T-shaped channel is an aperture formed in an insertion end of said male end.

10. The piping of claim 1, wherein said T-shaped channel includes a receiving length which has an axial orientation.

11. The piping of claim 10, wherein said T-shaped channel includes a first arm and a second arm each extending generally transversely from said receiving length.

12. The piping of claim 11, wherein said first arm and said second arm each extend about 90 degrees from said axial orientation.

13. The piping of claim 11, wherein said first arm and said second arm each extend less than 90 degrees from said axial orientation.

14. The piping of claim 11, wherein said first arm and said second arm each extend more than 90 degrees from said axial orientation.

15. A piping having releasable lockable connection, comprising:
a female pipe including a female end and a T-shaped channel formed on said female end of said female pipe; and
a male pipe including a male end having a locking bead sized and shaped to be received within said T-shaped channel when said male end is inserted into said female end to form piping having releasable lockable connection.

16. The piping of claim 15, wherein said locking bead is retained in said T-shaped channel when said male pipe is fully inserted and then radially twisted with respect to said female pipe.

17. The piping of claim 15, wherein said female end has a first diameter and said male end has a second diameter, said second diameter being smaller than said first diameter.

18. The piping of claim 15, wherein said locking bead protrudes from an inside surface of said male pipe.

19. The piping of claim 15, wherein said male pipe has one locking bead and said female pipe has one T-shaped channel.

20. The piping of claim 15, wherein said male pipe has one or more of said locking bead and said female pipe has one or more of said T-shaped channel.

21. The piping of claim 15, wherein said male pipe has one of said locking bead and said female pipe has a plurality of said T-shaped channels.

22. The piping of claim, 15 wherein said T-shaped channel is a convex shaped element.

23. The piping of claim, 15 wherein said T-shaped channel is an aperture formed in an insertion end of said female end.

24. The piping of claim 15, wherein said T-shaped channel includes a receiving length which has an axial orientation.

25. The piping of claim 24, wherein said T-shaped channel includes a first arm and a second arm each extending generally transversely from said receiving length.

26. The piping of claim 25, wherein said first arm and said second arm each extend about 90 degrees from said axial orientation.

27. The piping of claim 25, wherein said first arm and said second arm each extend less than 90 degrees from said axial orientation.

28. The piping of claim 25, wherein said first arm and said second arm each extend more than 90 degrees from said axial orientation.
